(19) United States
(12) Patent Application Publication
(10) Pub. No.: US 2020/0050902 A1
(43) Pub. Date: Feb. 13, 2020

(54) METHOD FOR ANALYZING MATERIAL USING NEURAL NETWORK BASED ON MULTIMODAL INPUT AND APPARATUS USING THE SAME

(71) Applicant: ELECTRONICS AND TELECOMMUNICATIONS RESEARCH INSTITUTE, Daejeon (KR)

(72) Inventors: Seung-Min CHOI, Daejeon (KR); Hyo-Bong HONG, Daejeon (KR); Jae-Chan JONG, Daejeon (KR)

(21) Appl. No.: 16/535,729

(22) Filed: Aug. 8, 2019

(30) Foreign Application Priority Data
Aug. 9, 2018 (KR) 10-2018-0093160
Oct. 25, 2018 (KR) 10-2018-0128229
Jul. 18, 2019 (KR) 10-2019-0086902

(51) Int. Cl. G06K 9/62; G06N 3/08; G06N 20/00

(52) U.S. Cl. CPC G06K 9/6293; G06N 20/00; G06N 3/084; G06K 9/629

(57) ABSTRACT

Disclosed herein are a method for analyzing material using a neural network based on multimodal input and an apparatus for the same. The method includes obtaining multimodal sensor data pertaining to at least one type of material to be analyzed using a multimodal sensor and augmenting the multimodal sensor data; merging the multimodal sensor data; training a neural network, provided for classifying the at least one type of material to be analyzed, using the merged multimodal sensor data; and classifying the type of target material by inputting multimodal sensor data pertaining to the target material, which is obtained using the multimodal sensor data, to the neural network.

### CROSS REFERENCE TO RELATED APPLICATIONS

This application claims the benefit of Korean Patent Application No. 10-2018-0093160, filed Aug. 9, 2018, No. 10-2018-0128229, filed Oct. 25, 2018, and No. 10-2019-0086902, filed Jul. 18, 2019, which are hereby incorporated by reference in their entireties into this application.

### BACKGROUND OF THE INVENTION

### 1. Technical Field

The present invention relates generally to technology for analyzing material, and more particularly to technology for identifying the type of material or analyzing an extent of reaction to the material using a previously trained neural network without preprocessing the material using a general wet chemical reaction.

### 2. Description of the Related Art

In the chemistry field, the field of qualitatively perceiving a chemical substance or analyzing chemical reaction phenomena is referred to as ‘analytical chemistry’. Analytical chemistry is treated as an independent field of study because it accounts for a great portion of the chemistry and chemical engineering fields.

Before the development of modern analytical instruments, material was analyzed using a weight, mass, a specific gravity, a fusion point, reactions with acids and bases, and the like pertaining thereto, in which case the obtained results depend considerably on the experience of those who conduct the experiments. Since the 19th century, it has become common to use electronic equipment to analyze chemical substances and to secure analytical signals using such equipment, but the final analysis of the signals still depends on the knowledge and experience of humans.

Recently, with the digitalization of chemical analysis instruments, signals are mostly quantified and processed using a computer, but the analysis of chemical substances and the determination of the extent of reaction using the signals are still performed by humans.

However, it is becoming more difficult and tougher for humans to analyze signals because the amount of signals that is obtained has enormously increased, and data, which was unavailable in the past, is also obtained with the advancement of analytical instruments. It is theoretically possible for humans to analyze and compare hundreds to millions of copies of experimental data and normalize the signal of certain material, but this is inefficient in practice because of the large amount of resources that are consumed.

Accordingly, efforts to solve these problems using a database have been attempted in many analytical techniques. In the case of expensive chemical analysis instruments, a database that is more expensive than the analysis equipment itself is required.

However, an analysis method using a database has a lot of limitations. Basically, environmental factors, such as humidity, temperature, the presence of light, and the like, or variation in a signal, such as white noise or the like attributable to a problem with the analytical instrument itself, may cause an analytical signal to vary even when the same chemical substance is analyzed using the same analytical technique. This causes humans to repeat analysis based on experiments and on a huge amount of data.

### DOCUMENTS OF RELATED ART

(Patent Document 1) Korean Patent Application Publication No. 10-2018-0093549, published on Aug. 22, 2018 and titled “Apparatus for measuring matching material and method therefor”.

### SUMMARY OF THE INVENTION

An object of the present invention is to provide a method for analyzing the type of material or an extent of reaction to the material using a previously trained neural network without preprocessing the material using a general wet chemical reaction.

Another object of the present invention is to improve material classification and analysis performance by simultaneously measuring a temperature, a weight, a color, and the like, related to the characteristics of material, as well as RF sensor data, by inputting the simultaneously measured data to a neural network in a multimodal form, and by processing the same.

A further object of the present invention is to attempt the automation of analysis based on a neural network in a field in which artificial intelligence is not commonly used, thereby seizing initiative in the relevant field.

Yet another object of the present invention is to provide an augmentation technique suitable for a multimodal sensor in order to prevent overfitting in a neural network.

Still another object of the present invention is to provide a method for merging and processing measured data in a multimodal form in order to increase the signal-to-noise ratio of a multimodal sensor.

In order to accomplish the above objects, a method for analyzing material using a neural network based on multimodal input according to the present invention includes obtaining multimodal sensor data pertaining to at least one type of material to be analyzed using a multimodal sensor and augmenting the multimodal sensor data; merging the multimodal sensor data; training the neural network using the merged multimodal sensor data; and inputting multimodal sensor data pertaining to target material, obtained using the multimodal sensor, to the neural network, thereby classifying the type of the target material.

Here, merging the multimodal sensor data may be configured to merge the multimodal sensor data using any one of a first merging method, in which merging is performed when the multimodal sensor data is input, and a second merging method, in which merging is performed when features of the multimodal sensor data are extracted.

Here, the first merging method may include merging in a data element domain and merging in a data channel domain.

Here, the second merging method may include merging in a feature element domain and merging in a feature channel domain.

Here, augmenting the multimodal sensor data may be configured to augment data in a manner corresponding to each type of the multimodal sensor data.

Here, the multimodal sensor may include an RF sensor, a temperature sensor, a weight sensor, a mass sensor, an IR sensor, and an RGB sensor.

Here, the multimodal sensor data may be collected based on a repeated experiment on the at least one type of material until an amount of the multimodal sensor data becomes equal to or greater than a preset reference amount.

Here, the method may further include repeatedly inserting and removing the at least one type of material to be analyzed in and from an RF resonator a preset number of times using a 3-axis robot, the RF resonator being shielded from an external magnetic field; forming a magnetic field in a preset frequency range inside the RF resonator by applying an electromagnetic wave using a network analyzer while the at least one type of material is placed in the RF resonator, and measuring a response signal caused by the at least one type of material; and generating the multimodal sensor data based on the response signal.

Here, measuring the response signal may be configured to determine whether the at least one type of material to be analyzed is placed in the RF resonator based on information about control of the 3-axis robot, and repeatedly inserting and removing the at least one type of material to be analyzed may be configured to determine a time at which the at least one type of material to be analyzed is to be removed in consideration of at least one of whether the response signal is measured and a preset response signal measurement time.

Here, the network analyzer may include two antennas that are capable of being inserted into the RF resonator, and the two antennas may be inserted into the RF resonator such that the two antennas are prevented from coming into contact with the surface of the RF resonator.

Also, an apparatus for analyzing material using a neural network based on multimodal input according to an embodiment of the present invention includes a processor for obtaining multimodal sensor data pertaining to at least one type of material to be analyzed using a multimodal sensor, augmenting the multimodal sensor data, merging the multimodal sensor data, training the neural network using the merged multimodal sensor data, and classifying the type of target material by inputting multimodal sensor data pertaining to the target material, which is obtained using the multimodal sensor, to the neural network; and memory for storing the multimodal sensor data and the neural network.

Here, the processor may merge the multimodal sensor data using any one of a first merging method, in which merging is performed when the multimodal sensor data is input, and a second merging method, in which merging is performed when features of the multimodal sensor data are extracted.

Here, the first merging method may include merging in a data element domain and merging in a data channel domain.

Here, the second merging method may include merging in a feature element domain and merging in a feature channel domain.

Here, the processor may augment data in a manner corresponding to each type of the multimodal sensor data.

Here, the multimodal sensor may include an RF sensor, a temperature sensor, a weight sensor, a mass sensor, an IR sensor, and an RGB sensor.

Here, the multimodal sensor data may be collected based on a repeated experiment on the at least one type of material until an amount of the multimodal sensor data becomes equal to or greater than a preset reference amount.

Here, the processor may be configured to repeatedly insert and remove the at least one type of material to be analyzed in and from an RF resonator a preset number of times using a 3-axis robot, the RF resonator being shielded from an external magnetic field, to form a magnetic field in a preset frequency range inside the RF resonator by applying an electromagnetic wave using a network analyzer while the at least one type of material to be analyzed is placed in the RF resonator, to measure a response signal caused by the at least one type of material to be analyzed, and to generate the multimodal sensor data based on the response signal.

Here, the processor may determine whether the at least one type of material to be analyzed is placed in the RF resonator based on information about control of the 3-axis robot and determine a time at which the at least one type of material to be analyzed is to be removed in consideration of at least one of whether the response signal is measured and a preset response signal measurement time.

Here, the network analyzer may include two antennas that are capable of being inserted into the RF resonator, and the two antennas may be inserted into the RF resonator such that the two antennas are prevented from coming into contact with the surface of the RF resonator.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that shows a material analysis system using a neural network based on multimodal input according to an embodiment of the present invention;

FIG. 2 is a flowchart that shows a material analysis method using a neural network based on multimodal input according to an embodiment of the present invention;

FIG. 3 is a view that shows an example of augmentation of multimodal sensor data according to the present invention;

FIG. 4 is a view that shows an example of the process of classifying material using only an RF sensor;

FIG. 5 is a view that shows an example of the RGB image and the IR image of material according to the present invention;

FIG. 6 and FIG. 7 are views that show an example of the process of classifying material using multimodal sensor data according to the present invention;

FIG. 8 is a flowchart that specifically shows a neural-network-training process according to an embodiment of the present invention;

FIGS. 9 to 11 are views that show an example of an RF resonator according to the present invention;

FIG. 12 is a view that shows an example of a 3-axis robot according to the present invention;

FIG. 13 is a view that shows an example of the input/output screen of a system according to the present invention; and

FIG. 14 is a block diagram that shows an apparatus for analyzing material using a neural network based on multimodal input according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

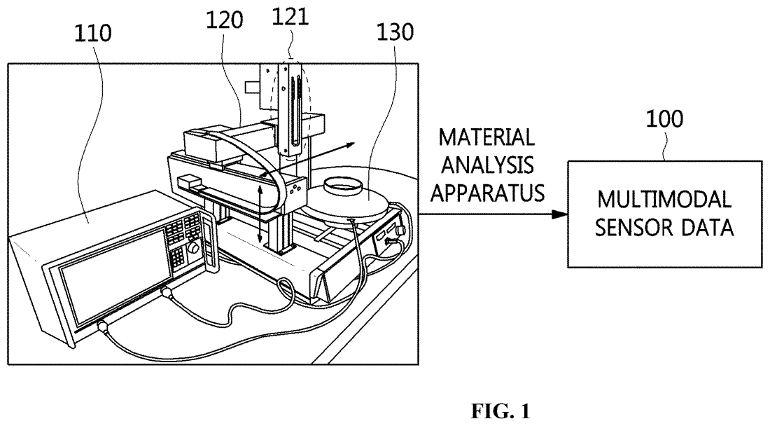

FIG. 1 is a view that shows a material analysis system using a neural network based on multimodal input according to an embodiment of the present invention.

Referring to FIG. 1, the material analysis system using a neural network based on multimodal input according to an embodiment of the present invention includes a material analysis apparatus 100, a network analyzer 110, a 3-axis robot 120, and an RF resonator 130.

The material analysis apparatus 100 obtains multimodal sensor data pertaining to at least one type of material to be analyzed using a multimodal sensor and augments the multimodal sensor data.

Here, for each type of multimodal sensor data, the data may be augmented in a different manner that suits the type thereof.

Here, the multimodal sensor may include an RF sensor, a temperature sensor, a weight sensor, a mass sensor, an IR sensor, and an RGB sensor.

Here, the multimodal sensor data may be collected by repeating an experiment on at least one type of material to be analyzed until the amount thereof becomes equal to or greater than a preset reference amount.

Also, the material analysis apparatus 100 repeatedly inserts and removes at least one type of material to be analyzed in and from the RF resonator 130 a preset number of times using the 3-axis robot 120. Here, the inner space of the RF resonator 130 is shielded from an external magnetic field.

Here, the RF resonator 130 may be a cylindrical RF resonator, the inner space of which is not affected or is minimally affected by an external magnetic field. For example, the RF resonator 130 may be made of aluminum or brass.

Here, in consideration of at least one of whether a response signal is measured and a preset response signal measurement time, the time at which at least one type of material to be analyzed is to be removed from the RF resonator 130 may be determined.

Here, the 3-axis robot 120 may place at least one type of material to be analyzed in the center of a material insertion hole in the RF resonator 130 using a robot arm 121. Here, the robot arm 121 is able to enter the RF resonator 130 via the material insertion hole, and at least one type of material to be analyzed is attachable to or detachable from the robot arm 121.

Here, the movement line, along which the robot arm 121 is to move, may be set in consideration of at least one of the position of the RF resonator 130 relative to that of the 3-axis robot 120 and the depth of the material insertion hole, and the movement of the robot arm 121 may be controlled so as to match the set movement line.

Also, while at least one type of material is placed inside the RF resonator 130, the material analysis apparatus 100 forms a magnetic field in a preset frequency range in the RF resonator 130 by applying an electromagnetic wave using the network analyzer 110 and measures a response signal caused by the at least one type of material.

For example, an electromagnetic wave is applied to the interior of the RF resonator 130 using a vector network analyzer (VNA) or a scalar network analyzer (SNA), which is capable of measuring a dielectric constant, whereby an electromagnetic field in a frequency range of 0.8 GHz to 4 GHz may be generated in the RF resonator 130.

Here, the network analyzer 110 may have two antennas that can be inserted into the RF resonator 130 in order to calculate a dielectric constant based on a permeability coefficient (S₂₁) of S-parameters.

Here, the two antennas may be inserted such that they are not in contact with the surface of the RF resonator 130.

Here, whether at least one type of material to be analyzed is placed inside the RF resonator 130 may be determined based on the control information pertaining to the 3-axis robot 120.

Also, the material analysis apparatus 100 generates multimodal sensor data based on the response signal.

That is, multimodal sensor data may be repeatedly generated based on a response signal that is measured each time the 3-axis robot 120 inserts and removes at least one type of material to be analyzed in and from the RF resonator 130.

As described above, the material analysis apparatus 100 according to an embodiment of the present invention may simultaneously control the function of inserting and removing at least one type of material to be analyzed in and from the RF resonator 130 using the 3-axis robot 120 and the function of applying an electromagnetic wave to the RF resonator 130 using the network analyzer 110 and measuring a response signal.

That is, the processes of applying an electromagnetic wave to the interior of the RF resonator 130 using the network analyzer 110 while at least one type of material to be analyzed is placed inside the RF resonator 130, obtaining a response signal caused by the at least one type of material, processing the response signal simultaneously with removing the at least one type of material from the RF resonator 130, and thereby generating and storing multimodal sensor data, are repeated, whereby data for training a neural network may be automatically obtained.

Also, the material analysis apparatus 100 merges the multimodal sensor data.

Here, the multimodal sensor data may be merged using any one of a first merging method, in which merging is performed when the multimodal sensor data is input, and a second merging method, in which merging is performed when the features of the multimodal sensor data are extracted.

Here, the first merging method may include merging in a data element domain and merging in a data channel domain.

Here, the second merging method may include merging in a feature element domain and merging in a feature channel domain.

Also, the material analysis apparatus 100 trains a neural network based on the merged multimodal sensor data.

Also, the material analysis apparatus 100 classifies the type of target material by inputting multimodal sensor data pertaining to the target material, which is obtained using the multimodal sensor, to the trained neural network.

Through the above-described process, it is possible to analyze the type of material or an extent of reaction to the material using a previously trained neural network without preprocessing the material using a general wet chemical reaction.

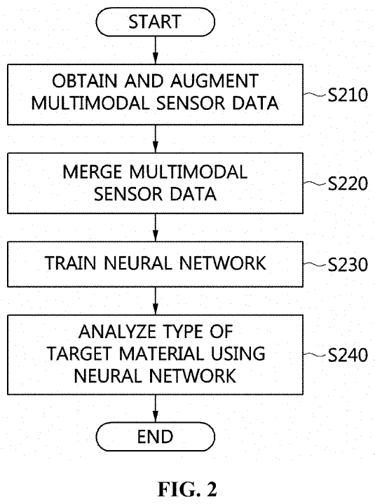

FIG. 2 is a flowchart that shows a method for analyzing material using a neural network based on multimodal input according to an embodiment of the present invention.

Referring to FIG. 2, in the method for analyzing material using a neural network based on multimodal input according to an embodiment of the present invention, multimodal sensor data pertaining to at least one type of material to be analyzed is obtained using a multimodal sensor, and the multimodal sensor data is augmented at step S210.

The process of obtaining data necessary for deep learning is time-consuming, and extensive resources are consumed therefor. Therefore, the present invention uses a method for increasing the size of a dataset by augmenting the multimodal sensor data, which is obtained by repeating an experiment an appropriate number of times.

Here, the format of data measured by conducting an experiment once, that is, a data frame, may vary for each sensor. Here, assuming that 3D data is acquired, the amount of measured data may be calculated as follows.

single data size(frame)=C(channel)*H(height)*W(width)

data size(material)=M(test count)*C*H*W

total database size=A(data augmentation number)*N(classes of material)*M*C*H*W

That is, the amount of data (A*N*M*C*H*W) augmented using the above method becomes very large. Therefore, in terms of storage space or consumed time, it is inefficient to compare these data values one by one when a material is analyzed. Also, data may be classified using a linear/nonlinear classifier after the entire dataset is transformed so as to be mapped to feature space having a smaller number of dimensions than the actual data. However, it is not easy to design feature space for each data type or to select a linear/nonlinear classifier suitable therefor.

Accordingly, the present invention proposes an augmentation method suitable for multimodal sensor data as follows.

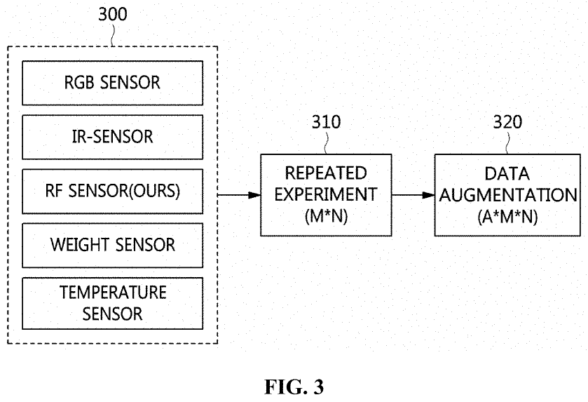

For example, referring to FIG. 3, multimodal sensor data may be obtained using a multimodal sensor 300 according to an embodiment of the present invention. Here, the multimodal sensor may include an RF sensor, a temperature sensor, a weight sensor, a mass sensor, an IR sensor, and an RGB sensor.

Here, the RF sensor is provided in order to check a change in a dielectric constant due to a certain material. For example, when a certain material is placed in the vicinity of an RF antenna, the dielectric constant at the corresponding position changes from the dielectric constant of air to the dielectric constant of the certain material, which may affect an RF signal. Therefore, when the certain material is placed between a transmission antenna and a reception antenna, a change in transmitted and received signals at each frequency may be measured using a vector network analyzer (VNA), whereby a change in a dielectric constant by the certain material may be checked.

However, the RF sensor is sensitive to magnetic-field-blocking performance, and a signal may vary depending on the temperature, weight, mass, shape, and the like of material. That is, such variation decreases a Signal-to-Noise Ratio (SNR) and affects the performance of a classifier for classifying certain material.

Accordingly, the present invention simultaneously obtains pieces of information, such as the temperature, the weight or mass, the shape, the color, and the like of the material, additionally using a temperature sensor, a weight sensor, a mass sensor, an IR sensor, and an RGB sensor, and uses the obtained information in order to analyze the material.

For example, the temperature of the material to be analyzed is measured using a contactless temperature measurement sensor, in which case the average of temperatures measured at two or more points may be output as the measured temperature. Also, the weight of the material to be analyzed may be measured using a weight measurement sensor included in a table on which the material is placed. Also, in the case of the color of the material to be analyzed, a white balance must be provided. Therefore, the view angles of a fixed RGB camera and a fixed IR camera are set such that the range thereof includes the position at which the material to be analyzed is to be placed, and a true white card or a true gray card is attached to a fixed position, whereby the material and the color card may be captured together. If the white card is captured along with the material, an average is calculated for each RGB channel of the white region in the captured image. Here, because the white balance is adjusted so as to match true white when each average becomes 1, R, G, and B values are divided by the respective average values for all of the pixels in a corresponding frame (a bundle of 1D data measured through frequency sweeping at an arbitrary time), whereby the effect of lighting on the measured color of the material may be excluded.

In the present invention, an experiment for obtaining data may be repeatedly performed on at least one type of material to be analyzed at step 310 in order to prevent overfitting, which is a phenomenon in which an error rate increases when material is analyzed and classified. Accordingly, as much data as possible may be secured (M (test count)*N (classes of material)) before data augmentation.

Here, the larger the number of valid frames in data for training a neural network for analyzing material, the easier it is to solve the overfitting problem. Therefore, at step 320, data augmentation may be performed for the multimodal sensor data, which is obtained through repeated experimentation (A (data augmentation number)*M (test count)*N (classes of material)).

Here, for each type of multimodal sensor data, the data may be augmented in a different manner that suits the type thereof.

For example, 1D data included in the multimodal sensor data may be augmented using the method shown in Table 1 in the present invention.

TABLE 1

| No. | augmentation | function | description |
|---|---|---|---|
| 1 | x-axis random shift | shift the entire data of a | x-axis noise effect |
| | (RF sensor) | corresponding frame in an x- | |
| | | axis direction within a preset | |
| | | margin | |
| 2 | y-axis random scale | multiply the entire Y-axis data | compensate for signal |
| | (RF sensor) | by a random scale within a | strength (offset effect) |
| | | preset margin | |
| 3 | y-axis random noise | add random noise to Y-axis data | y-axis noise effect |
| | (RF sensor) | within a preset margin | |
| 4 | hybrid | (1 + 2), (1 + 3), (2 + 3), (1 + 2 + 3) | apply mixture of three |
| | (RF sensor) | | augmentation methods to RF |
| | | | sensor |
| 5 | temperature sensor | add random noise within a | temperature sensor noise |
| | | preset margin | |
| 6 | weight sensor | add random noise within a | mass sensor noise |
| | | preset margin | |
| 7 | RGB sensor | rigid transformation ([rotation\| | consider the variation in a |
| | IR sensor | translation]) of the entire image | position and gradient that |
| | | within a preset margin (the same | may occur when the material |
| | | transformation is performed for | to be analyzed is placed on a |
| | | an RGB image and an IR image) | table. |

Here, the data of the RF sensor is signal reflectance at each frequency, in which case an x-axis value may indicate a frequency and a y-axis value may indicate reflectance at the corresponding frequency.

Also, in the method for analyzing material using a neural network based on multimodal input according to an embodiment of the present invention, the multimodal sensor data is merged at step S220.

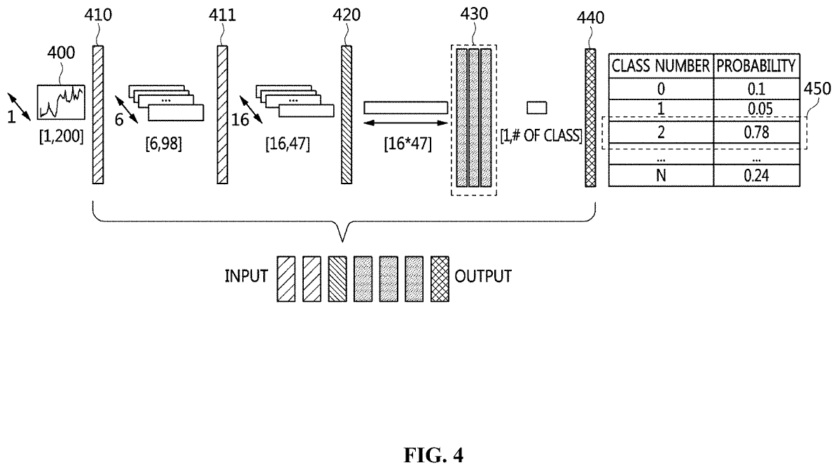

In the conventional method, material is analyzed using only RF sensor data 400, as shown in FIG. 4, and the structure of a neural network itself is not different from the existing neural network used for image processing. However, when the feature signal of material is obtained using an RF sensor and is augmented and then input to the neural network shown in FIG. 4 for training, the neural network may function as a chemical material classifier that is capable of identifying the type or state of material. This method is very accurate and simple compared to the existing method, in which an antenna is used and the features of the material are identified through analysis based on human experience.

Further, the present invention additionally proposes a neural network for merging and processing multimodal sensor data in order to improve classification performance.

Here, the multimodal sensor data may be merged using any one of a first merging method, in which merging is performed when the multimodal sensor data is input, and a second merging method, in which merging is performed when the features of the multimodal sensor data are extracted.

Here, the first merging method may include merging in a data element domain and merging in a data channel domain.

Here, the second merging method may include merging in a feature element domain and merging in a feature channel domain.

Here, the first merging method and the second merging method may be summarized as shown in Table 2

TABLE 2

| No. | merging method | function | description |
|---|---|---|---|
| 1 | input data element | concatenation in a data element domain in | input data-wise |
| | concatenation | the data input step | |
| 2 | input data channel | concatenation in a data channel domain in | input channel-wise |
| | concatenation | the data input step | |
| 3 | feature data | concatenation in a feature element domain | feature data-wise |
| | element | in the feature extraction step after passing a | |
| | concatenation | separate network for each type of sensor | |
| | | data | |
| 4 | feature data | concatenation in a feature channel domain | feature channel-wise |
| | channel | in the feature extraction step after passing a | |
| | concatenation | separate network for each type of sensor | |
| | | data | |

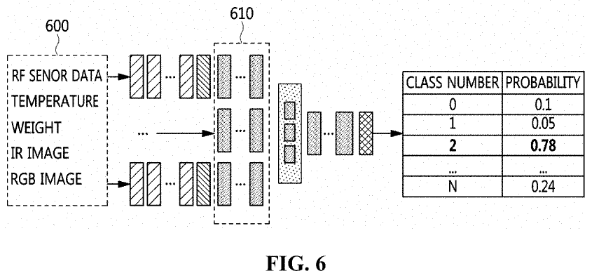

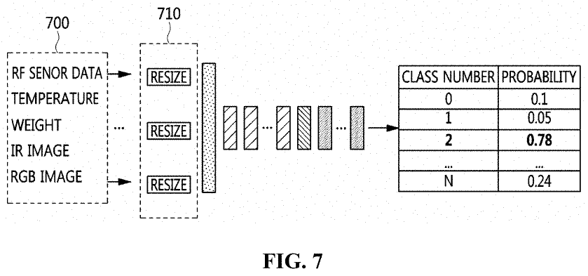

Also, referring to FIG. 6 and FIG. 7, a process in which RF sensor data and sensor data pertaining to material, such as a temperature, a weight, an IR image, an RGB image, and the like, are simultaneously input and used for training of a neural network according to an embodiment of the present invention is illustrated.

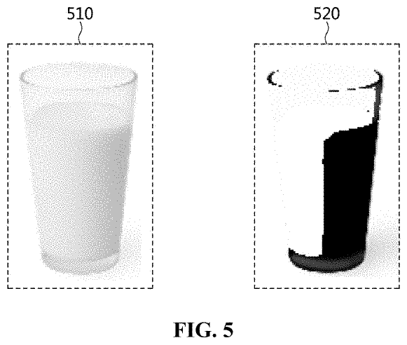

Here, even if the same material is analyzed, because the temperature and weight of the material are related to a dielectric constant, they may affect RF sensor data. Also, the overall shape of the material may be detected using the RGB image 510 shown in FIG. 5, and the temperature of the material may be detected using the IR image 520. Here, infrared light has good transmittivity because it has a longer wavelength than red light. Accordingly, infrared light is suitable for use as a material analysis signal.

As described above, because each of the various types of multimodal sensor data has a different number of channels and a different size, the material analysis and classification performance may also be different depending on the method of merging the multimodal sensor data.

For example, a temperature and a weight may be 1×1 data represented as a single number corresponding to the average value, and RF sensor data may be 1 xN data, which may vary depending on a frequency span. Also, an RGB image or an IR image may be 2D data, the size of which is set to 640×480, 1280×720, or higher.

These types of multimodal sensor data may be merged by combining a convolution layer and a subsampling layer at the feature level or by adjusting the number of input/output features of a fully connected layer and delivering the features to the next layer, as shown in FIG. 6.

Here, the process of merging multimodal sensor data at the data-merging point 610 is described in detail as follows.

First, the number of input/output nodes of a fully connected layer is adjusted, whereby the features input from multiple nodes may be concatenated as a single feature. For example, the dimensions of three features input for the same material are 10000, 40, and 40000, but the dimensions may become equal and have the same value, for example, 300, by passing three levels of fully connected layers.

Here, if it is obvious that any specific type of input data contributes to identifying the type of material to be analyzed corresponding to the input data, a larger number of dimensions may be assigned to the data that makes a large contribution, rather than making the dimensions equal. However, when it is difficult to estimate the level of contribution, dimensions are made equal and concatenated, and the level of contribution of the feature to loss may be determined depending on a weight value computed through training.

Also, the multimodal sensor data 700 may be merged by resizing data at the input level, as shown in FIG. 7.

Also, in the method for analyzing material using a neural network based on multimodal input according to an embodiment of the present invention, the neural network is trained based on the merged multimodal sensor data at step S230.

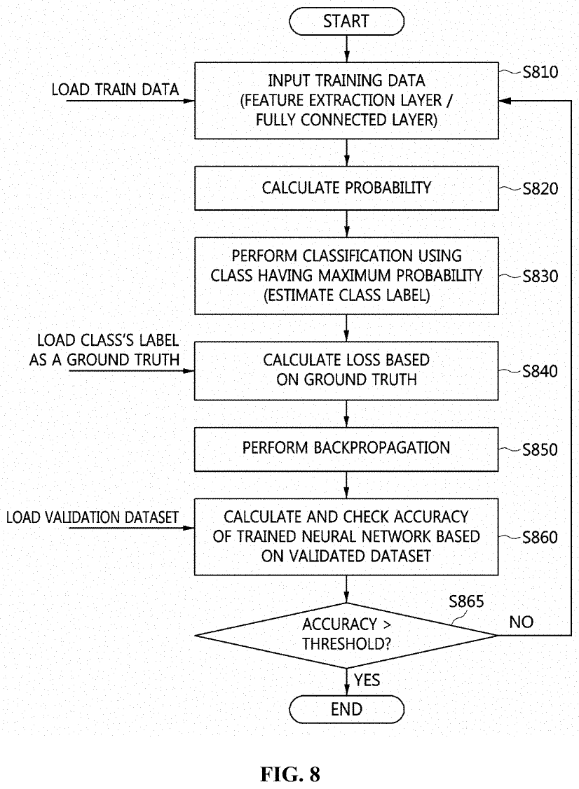

For example, referring to FIG. 8, training data, which is obtained through data augmentation and merging, is sequentially or randomly input to the neural network, whereby the weights thereof may be computed through training at step S810. Here, the weights may be the weights of neurons in each layer in the neural network.

Then, the probability that the input data falls into each class is calculated at step S820, and a prediction (a class label) may be calculated at step S830 for the class having the maximum probability, among the calculated probabilities.

Here, the process of steps S820 to S830 may correspond to forward processing.

Then, the class label of ground truth is input from a database, whereby the loss, which is the difference from the prediction, may be calculated at step S840.

Then, backpropagation, in which a weight, which is provided for each of the neurons in each layer, is decreased by multiplying the level of contribution of the weight to the loss by the learning rate, is performed at step S850, whereby one training cycle of a neural network may be performed.

Then, the accuracy of the trained neural network is calculated at step S860 based on the validated dataset stored in the database, and whether the calculated accuracy exceeds a preset threshold may be determined at step S865.

When the accuracy is determined to exceed the preset threshold at step S865, the neural network is determined to be sufficiently trained, and thus training may be terminated.

Also, when it is determined at step S865 that the accuracy does not exceed the preset threshold, the steps of S810 to S860 are repeatedly performed, whereby training of the neural network is repeatedly performed.

With regard to the repetition of training, it may be determined that one epoch is completed when the entire training dataset stored in the database is fed to the neural network or when only a portion thereof is fed to the neural network using a mini-batch method. Such an epoch may be repeated until a desired accuracy is achieved.

Here, one epoch may mean that forward processing and backpropagation are performed for the entire dataset in an artificial neural network. That is, one epoch may mean that training using the entire dataset is completed once.

Also, in the method for analyzing material using a neural network based on multimodal input according to an embodiment of the present invention, multimodal sensor data pertaining to target material, which is obtained using the multimodal sensor, is input to the trained neural network, whereby the type of target material is classified at step S240.

For example, assuming that the neural network shown in FIG. 6 and FIG. 7 is a trained neural network, multimodal sensor data pertaining to the target material may be input thereto. Then, the value of the class estimated to have the maximum probability through the neural network may be determined to be the index of the target material.

That is, the target material, which is not yet identified, is measured using the multimodal sensor, and multimodal sensor data, which is the result of measurement, is input to the trained neural network, whereby the classification result indicating the type of target material may be output.

Here, the multimodal sensor data may be collected by repeating an experiment on the target material until the amount thereof becomes equal to or greater than a preset reference amount.

Hereinafter, a process for repeatedly performing an experiment in order to collect multimodal sensor data in the present invention will be described in detail.

Although not illustrated in FIG. 2, in the method for analyzing material using a neural network based on multimodal input according to an embodiment of the present invention, at least one type of material to be analyzed may be repeatedly inserted in and removed from an RF resonator a preset number of times using a 3-axis robot, the RF resonator being shielded from an external magnetic field.

For deep learning for analyzing a dielectric constant of chemical material, it is necessary to secure analysis data or training data pertaining to various types of material samples in an environment that is not affected by an external magnetic field.

Therefore, the RF resonator according to an embodiment of the present invention is made of aluminum or brass such that the inner space thereof is not affected by an external magnetic field and such that the electromagnetic wave applied to the interior of the RF resonator is prevented from escaping therefrom. Here, the RF resonator has a structure enabling various types of material to be analyzed to be inserted via a material insertion hole.

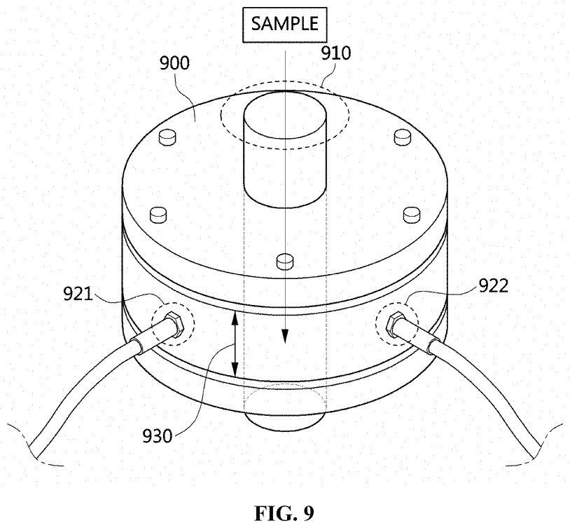

For example, the RF resonator according to an embodiment of the present invention may have a cylindrical shape and include a material insertion hole 910, via which the material to be analyzed is inserted in the RF resonator, as shown in FIG. 9. Here, the diameter of the material insertion hole 910 may be freely set when it is designed and produced, but may be set such that the interior of the RF resonator 900 is prevented from being affected by an external magnetic field. The RF resonator 900 is produced in such a way that the upper part and the lower part thereof are combined, whereby an electromagnetic field in a preset frequency range may be formed in the empty inner space thereof.

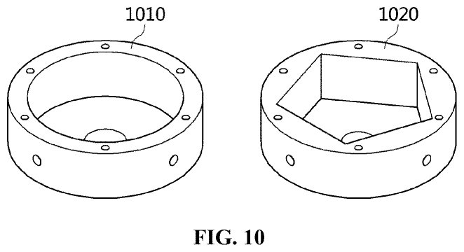

For example, when the part 1010 of the RF resonator shown in FIG. 10 is combined with an identical part that is upside down such that the two identical parts form a symmetric shape, a cylindrical RF resonator having empty space therein may be produced, and the corresponding RF resonator may form an electromagnetic field in a preset frequency range in the cylindrical empty space thereof. Also, when the part 1020 of the RF resonator shown in FIG. 10 is combined with an identical part that is upside down such that the two identical parts form a symmetric shape, an RF resonator, the empty inner space of which has a pentagonal pillar shape, may be produced, and the corresponding RF resonator may form an electromagnetic field in a preset frequency range in the empty inner space having a pentagonal pillar shape.

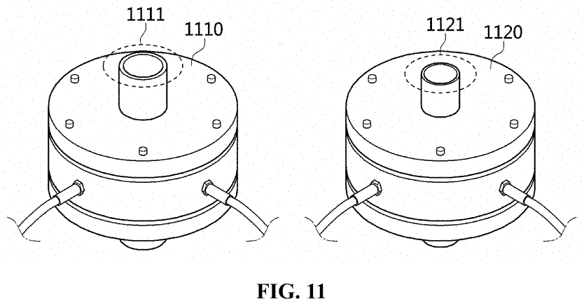

Also, referring to FIG. 11, the material insertion hole 1111 or 1121 in the RF resonator 1110 or 1120 according to an embodiment of the present invention may be configured to have a different size according to need.

As described above, the RF resonator according to an embodiment of the present invention may be produced so as to have any of various shapes depending on the chemical material to be analyzed or the requirements of an analyzer. However, the structure of the RF resonator is required to enable material to be inserted therein and to enable an electromagnetic field in a certain frequency range to be formed therein. Also, the RF resonator according to an embodiment of the present invention may be produced so as to be suitable for measuring a minute change in material, of which the main ingredient is water, such as distilled water, milk, or the like.

Also, the 3-axis robot according to an embodiment of the present invention may be designed such that it is able to repeatedly place the material to be analyzed in the RF resonator 130, as shown in FIG. 1.

Here, when the material to be analyzed is inserted, the material may be placed in the center of the material insertion hole in the RF resonator using a robot arm, which is capable of entering and leaving the RF resonator via the material insertion hole and is capable of attaching and detaching the material thereto and therefrom.

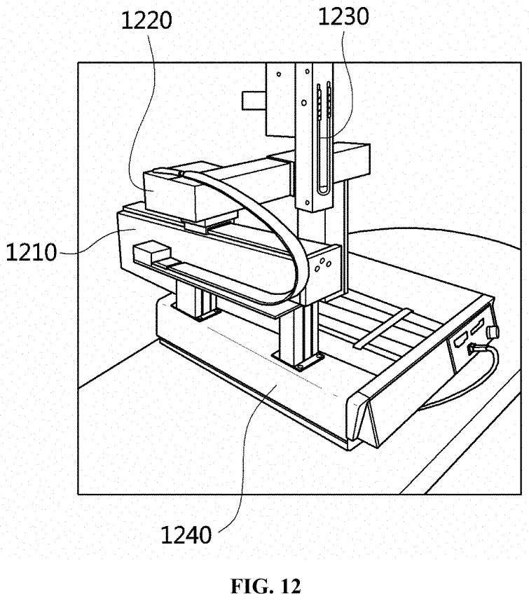

For example, referring to FIG. 12, the 3-axis robot according to an embodiment of the present invention may include two movement modules 1210 and 1220 for shifting the position of the material to be analyzed, a robot arm 1230 for inserting and removing the material in and from the RF resonator, and a plotter 1240 on which the RF resonator is placed so as to be fixed. That is, the material to be analyzed is attached to the bottom part of the robot arm 1230, and the robot arm 1230 is located above the material insertion hole of the RF resonator using the movement modules 1210 and 1220, whereby it may be ready to repeat the insertion and removal of the material to be analyzed. Then, the material to be analyzed may be inserted into the RF resonator by moving the robot arm 1230 down, or may be removed from the RF resonator by moving the robot arm 1230 up.

Here, the time at which the material to be analyzed is to be removed may be determined in consideration of at least one of whether a signal is measured and a preset signal measurement time.

For example, when it is confirmed that an electromagnetic wave is applied to the RF resonator and a response signal is measured in a network analyzer, which functions to measure a response signal from the material to be analyzed, the material to be analyzed may be removed from the RF resonator by controlling the robot arm of the 3-axis robot.

In another example, based on a response signal measurement time, which is the time taken to apply an electromagnetic wave using the network analyzer and measure a response signal after the material to be analyzed is inserted in the RF resonator, the time at which the material is to be removed may be determined, and the material may be removed at the determined time. If the response signal measurement time is 10 seconds, the material to be analyzed may be removed from the RF resonator 10 seconds after the robot arm inserts the material in the RF resonator.

Here, a movement line, along which the robot arm is to move, may be set in consideration of at least one of the position of the RF resonator relative to that of the 3-axis robot and the depth of the material insertion hole, and the movement of the robot arm may be controlled so as to match the set movement line.

For example, referring to FIG. 1, the distance by which the 3-axis robot is to move along each axis may be set in order to locate the robot arm 121 above the material insertion hole in the RF resonator 130. Then, the distance by which the robot arm 121 is to move may be set based on the depth of the material insertion hole such that the material to be analyzed is located at the center in the RF resonator 130. The movement line is set so as to match the set distances, whereby the movement of the robot arm 121 may be finely controlled.

Also, although not illustrated in FIG. 2, in the method for analyzing material using a neural network based on multimodal input according to an embodiment of the present invention, a magnetic field in a preset frequency range may be formed in the RF resonator by applying an electromagnetic wave using a network analyzer while at least one type of material to be analyzed is placed in the RF resonator, and a response signal from the material may be measured.

In the present invention, an electromagnetic wave is supplied in units of Hz using a network analyzer, such as a vector network analyzer or a scalar network analyzer, in order to form an electromagnetic field in a frequency range of 0.8 GHz to 3.5 GHz in the RF resonator, and a response signal for analyzing the absorptivity of the material to the electromagnetic field formed in the RF resonator is measured. Here, the scalar network analyzer may provide the same result as when the vector network analyzer is used, except that information about the phase of the response signal is not included in the result.

The network analyzer may apply an electromagnetic wave and measure a response signal only when the material to be analyzed is placed inside the RF resonator. Here, whether the material to be analyzed is placed inside the RF resonator may be determined based on the 3-axis robot control information.

For example, when it is confirmed that the material to be analyzed is inserted in the RF resonator by moving the robot arm based on the 3-axis robot control information, the network analyzer may be controlled so as to apply an electromagnetic wave and measure a response signal caused by the material to be analyzed.

Also, in the present invention, the time required for postprocessing, that is, for generating multimodal sensor data using the response signal measured through the network analyzer, is measured, and the time at which the robot arm again inserts the material to be analyzed in the RF resonator is calculated based on the measured time, whereby the time at which the network analyzer is to operate may be set.

For example, if it takes 10 seconds for the network analyzer to measure a response signal and generate multimodal sensor data, the robot arm may be controlled so as to again insert the material to be analyzed in the RF resonator 10 seconds after removing the material from the RF resonator. Accordingly, the network analyzer may also be operated so as to again apply an electromagnetic wave 10 seconds after the robot arm removes the material to be analyzed from the RF resonator, and may then measure a response signal.

Also, although not illustrated in FIG. 2, in the method for analyzing material using a neural network based on multimodal input according to an embodiment of the present invention, multimodal sensor data may be generated based on a response signal.

Here, the multimodal sensor data may be training data to be used to train a neural network, which is provided for analyzing the dielectric constant of the material to be analyzed. That is, in order to train the neural network so as to accurately analyze the dielectric constant of the material to be analyzed, so as to replace humans, a huge amount of training data may be required.

Therefore, if multimodal sensor data is automatically generated using the method proposed by the present invention, the percentage of analysis performed by humans is significantly reduced when a neural network is trained and chemical material is analyzed, whereby an analysis result may be more efficiently obtained.

Here, the dielectric constant of the material to be analyzed is calculated using the difference between a first voltage, corresponding to an electromagnetic wave applied to the RF resonator, and a second voltage, corresponding to a response signal, and multimodal sensor data may be generated based on multiple pieces of information about a dielectric constant repeatedly calculated a preset number of times.

Here, the dielectric constant is defined as the proportional amount of a decrease in a magnitude of an electromagnetic field in a dielectric due to the occurrence of dielectric polarization in response to an electromagnetic wave applied to the dielectric. In the present invention, the dielectric constant of the material to be analyzed may be calculated based on the difference between the first voltage and the second voltage, and the repeatedly calculated dielectric constant may be provided as multimodal sensor data for training the neural network.

Here, the network analyzer may include two antennas that can be inserted into the RF resonator in order to calculate a dielectric constant based on the permeability coefficient S₂₁ of S-parameters. For example, referring to FIG. 9, the RF resonator 900 according to an embodiment of the present invention may include two antenna insertion holes 921 and 922 in order to enable the network analyzer to analyze a permeability coefficient S₂₁ of S-parameters.

Here, an electromagnetic wave may be applied using one of the two antennas, and a response signal may be measured using the other antenna.

Here, the two antennas may be broadband antennas or antennas using metal wire. Accordingly, if the two antennas are in contact with the surface of the RF resonator, which is made of metal, an error in the measured signal may result. Therefore, the two antennas according to an embodiment of the present invention may be inserted so as to be prevented from coming into contact with the surface of the RF resonator.

For example, referring to FIG. 9, the two antennas to be inserted in the RF resonator 900 are produced such that the diameter thereof does not exceed the maximum inner width 930 of the RF resonator, whereby the two antennas may be prevented from coming into contact with the metal surface of the RF resonator 900.

Also, although not illustrated in FIG. 2, in the method for analyzing material using a neural network based on multimodal input according to an embodiment of the present invention, various kinds of information generated in the above-described process for analyzing material according to an embodiment of the present invention may be stored in a separate storage module.

Through the above-described method for analyzing material using a neural network based on multimodal input, a method for analyzing the type of material and an extent of reaction to the material using a previously trained neural network without preprocessing the material using a general wet chemical reaction may be provided.

Also, a method in which a human performs analysis based on only an RF sensor may be automated in the fields of analytical science and chemical processing, and classification performance may be significantly improved.

Also, not only RF sensor data but also a temperature, a weight, a color, and the like related to the features of the material are simultaneously measured and input to a neural network in a multimodal form so as to be processed, whereby material classification and analysis performance may be significantly improved.

Also, analysis automation based on a neural network is attempted in a field in which artificial intelligence is not commonly used, whereby initiative may be seized in the relevant field.

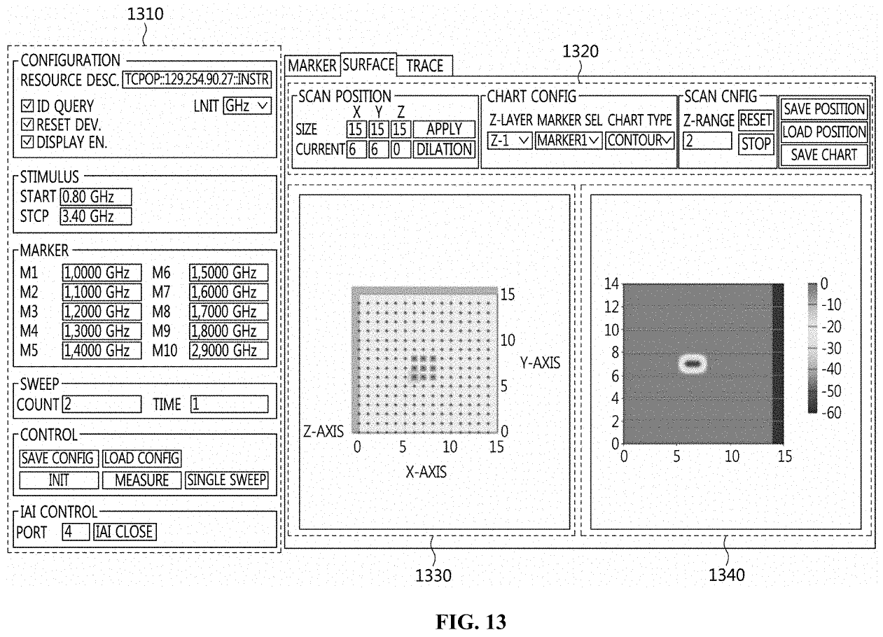

FIG. 13 is a view that shows an example of the input/output screen of a system according to an embodiment of the present invention.

Referring to FIG. 13, the system according to an embodiment of the present invention may provide a network analyzer parameter input screen 1310, a 3-axis robot control information input screen 1320, a control information details input screen 1330, and a signal display screen 1340.

The network analyzer parameter input screen 1310 may be provided for inputting the parameters of an instrument, such as a vector network analyzer or a scalar network analyzer. For example, parameters for setting an IP address, stimulus values at the start and end points of measurement, markers, communication with a 3-axis robot, and the like may be input, as shown in FIG. 13.

The 3-axis robot control information input screen 1320 is provided for controlling the movement of a 3-axis robot, and the distance by which the 3-axis robot is to move along each axis may be set in the 3-axis robot control information input screen 1320.

The control information details input screen 1330 is provided for minutely controlling the movement of the 3-axis robot at each point based on each axis of the 3-axis robot. The range within which the 3-axis robot is allowed to move is set in the 3-axis robot control information screen 1320, but the movement of the 3-axis robot within the set range may be set in the control information details input screen 1330.

The signal display screen 1340 may provide the response signal or data, actually obtained at the position specified based on each axis of the 3-axis robot, as an image. Here, a value obtained by actually measuring the response signal may also be displayed.

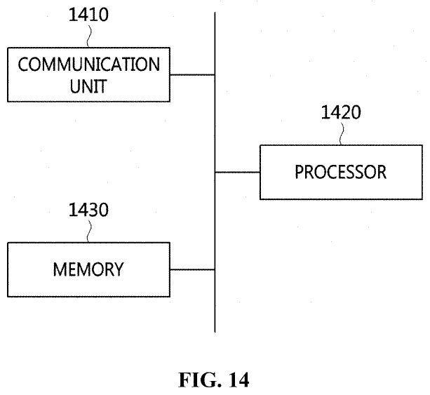

FIG. 14 is a block diagram that shows an apparatus for analyzing material using a neural network based on multimodal input according to an embodiment of the present invention.

Referring to FIG. 14, the apparatus for analyzing material using a neural network based on multimodal input according to an embodiment of the present invention includes a communication unit 1410, a processor 1420, and memory 1430.

The communication unit 1410 serves to transmit and receive information that is necessary in order to analyze material through a communication network. Particularly, the communication unit 1410 according to the present invention may receive multimodal sensor data from a multimodal sensor and transmit result data such that a material analysis result is output via a display module.

The processor 1420 acquires multimodal sensor data pertaining to at least one type of material to be analyzed using a multimodal sensor and augments the multimodal sensor data.

The process of obtaining data necessary for deep learning is time-consuming, and extensive resources are consumed therefor. Therefore, the present invention uses a method for increasing the size of a dataset by augmenting the multimodal sensor data, which is obtained by repeating an experiment an appropriate number of times.

Here, the format of data measured by conducting an experiment once, that is, a data frame, may vary for each sensor. Here, assuming that 3D data is acquired, the amount of measured data may be calculated as follows.

single data size(frame)=C(channel)*H(height)*W(width)

data size(Material)=M(test count)*C*H*W

total database size=A(data augmentation number)*N(classes of material)*M*C*H*W

That is, a huge amount of data (A*N*M*C*H*W) may be obtained by performing augmentation as described above. Therefore, in terms of storage space or consumed time, it is very inefficient to compare these data values one by one when a material is actually analyzed. Also, data may be classified using a linear/nonlinear classifier after the entire dataset is transformed so as to be mapped to feature space having a smaller number of dimensions than the actual data. However, it is not easy to design feature space for each data type or to select a linear/nonlinear classifier suitable therefor.

Accordingly, the present invention proposes an augmentation method suitable for multimodal sensor data as follows.

For example, referring to FIG. 3, multimodal sensor data may be obtained using a multimodal sensor 300 according to an embodiment of the present invention. Here, the multimodal sensor may include an RF sensor, a temperature sensor, a weight sensor, a mass sensor, an IR sensor, and an RGB sensor.

Here, the RF sensor may be provided in order to check a change in a dielectric constant due to a certain material. For example, when a certain material is placed in the vicinity of an RF antenna, the dielectric constant at the corresponding position changes from the dielectric constant of air to the dielectric constant of the certain material, which may affect an RF signal. Therefore, the certain material is placed between a transmission antenna and a reception antenna, and a change in the transmitted and received signals at each frequency is measured using a vector network analyzer (VNA), whereby a change in a dielectric constant by the certain material may be checked.

However, the RF sensor is sensitive to magnetic-field-blocking performance, and a signal may vary depending on the temperature, weight, mass, shape, and the like of material. That is, such variation decreases a Signal-to-Noise Ratio (SNR) and affects the performance of a classifier for classifying certain material.

Accordingly, the present invention simultaneously obtains additional information, such as the temperature, the weight or mass, the shape, the color, and the like of the material, using a temperature sensor, a weight sensor, a mass sensor, an IR sensor, and an RGB sensor, and uses the obtained information in order to analyze the material.

For example, the temperature of the material to be analyzed is measured using a contactless temperature measurement sensor, in which case the average of temperatures measured at two or more points may be output as the measured temperature. Also, the weight of the material to be analyzed may be measured using a weight measurement sensor included in a table on which the material is placed. Also, in the case of the color of the material to be analyzed, a white balance must be provided. Therefore, the view angles of a fixed RGB camera and a fixed IR camera are set such that the range thereof includes the position at which the material to be analyzed is to be placed, and a true white card or a true gray card is attached to a fixed position, whereby the material and the color card may be captured together. If the white card is captured along with the material, an average is calculated for each RGB channel of the white region in the captured image. Here, because the white balance is adjusted so as to match true white when each average becomes 1, R, G and B values are divided by the respective average values for all of the pixels in a corresponding frame (a bundle of 1D data measured through frequency sweeping at an arbitrary time), whereby the effect of lighting on the measured color of the material may be excluded.

In the present invention, an experiment for obtaining data may be repeatedly performed on at least one type of material to be analyzed at step 310 in order to prevent overfitting, which is a phenomenon in which an error rate increases when material is analyzed and classified. Accordingly, as much data as possible may be secured before data augmentation (M (test count)*N (classes of material)).

Here, the larger the number of valid frames in data for training a neural network for analyzing material, the easier it is to solve the overfitting problem. Therefore, at step 320, data augmentation may be performed for the multimodal sensor data, which is obtained through repeated experimentation (A (data augmentation number)*M (test count)*N (classes of material)).

Here, for each type of multimodal sensor data, the data may be augmented in a different manner that suits the type thereof.

For example, 1D data included in the multimodal sensor data may be augmented using the method shown in Table 1 in the present invention.

Here, the data of the RF sensor is signal reflectance at each frequency, in which case an x-axis value may indicate a frequency and a y-axis value may indicate reflectance at the corresponding frequency.

Also, the processor 1420 merges multimodal sensor data.

In the conventional method, material is analyzed using only RF sensor data 400, as shown in FIG. 4, and the structure of a neural network itself is not different from the existing neural network used for image processing. However, when the feature signal of material is obtained using an RF sensor and is augmented and then input to the neural network shown in FIG. 4 for training, the neural network may function as a chemical material classifier that is capable of identifying the type or state of material. This method is very accurate and simple compared to the existing method, in which an antenna is used and the features of the material are identified through analysis based on human experience.

Further, the present invention additionally proposes a neural network for merging and processing multimodal sensor data in order to improve classification performance.

Here, the multimodal sensor data may be merged using any one of a first merging method, in which merging is performed when the multimodal sensor data is input, and a second merging method, in which merging is performed when the features of the multimodal sensor data are extracted.

Here, the first merging method may include merging in a data element domain and merging in a data channel domain.

Here, the second merging method may include merging in a feature element domain and merging in a feature channel domain.

Here, the first merging method and the second merging method may be summarized as shown in Table 2.

Also, FIG. 6 and FIG. 7 illustrate a process in which RF sensor data and sensor data pertaining to material, such as a temperature, a weight, an IR image, an RGB image, and the like, are simultaneously input and used for training of a neural network according to an embodiment of the present invention.

Here, even if the same material is analyzed, because the temperature and weight of the material are related to a dielectric constant, they may affect RF sensor data. Also, the overall shape of the material may be detected using the RGB image 510 shown in FIG. 5, and the temperature of the material may be detected using the IR image 520. Here, infrared light has good transmittivity because it has a longer wavelength than red light. Accordingly, infrared light is suitable for use as a material analysis signal.

As described above, because each of the various types of multimodal sensor data has a different number of channels and a different size, the material analysis and classification performance may also be different depending on the method of merging the multimodal sensor data.

For example, a temperature and a weight may be 1×1 data represented as a single number corresponding to the average value, and RF sensor data may be 1 xN data, which may vary depending on a frequency span. Also, an RGB image or an IR image may be 2D data, the size of which is set to 640×480, 1280×720, or higher.

These types of multimodal sensor data may be merged by combining a convolution layer and a subsampling layer at the feature level or by adjusting the number of input/output features of a fully connected layer and delivering the features to the next layer, as shown in FIG. 6.

Here, the process of merging multimodal sensor data at the data-merging point 610 is described in detail as follows.

First, the number of input/output nodes of a fully connected layer is adjusted, whereby features input from multiple nodes may be concatenated as a single feature. For example, the dimensions of three features input for the same material are 10000, 40, and 40000, but the dimensions may become equal and have the same value, for example, 300, by passing three levels of fully connected layers.

Here, if it is obvious that any specific type of input data contributes to identifying the type of material to be analyzed corresponding to the input data, a larger number of dimensions may be assigned to data that makes a large contribution, rather than making the dimensions equal. However, when it is difficult to estimate the level of contribution, dimensions are made equal and concatenated, and the level of contribution of the feature to loss may be determined depending on a weight value computed through training.

Also, the multimodal sensor data 700 may be merged by resizing data at the input level, as shown in FIG. 7.

Also, the processor 1420 trains a neural network based on the merged multimodal sensor data.

For example, referring to FIG. 8, training data, which is obtained through data augmentation and merging, is sequentially or randomly input to the neural network, whereby the weights thereof may be computed through training at step S810. Here, the weights may be the weights of neurons in each layer in the neural network.

Then, the probability that the input data falls into each class is calculated at step S820, and a prediction (a class label) may be calculated for the class having the maximum probability, among the calculated probabilities, at step S830.

Here, the process of steps S820 to S830 may correspond to forward processing.

Then, the class label of ground truth is input from a database, whereby the loss, which is the difference from the prediction, may be calculated at step S840.

Then, backpropagation, in which a weight, which is provided for each of the neurons in each layer, is decreased by multiplying the level of contribution of the weight to the loss by the learning rate, is performed at step S850, whereby one training cycle of a neural network may be performed.

Then, the accuracy of the trained neural network is calculated at step S860 based on the validated dataset stored in the database, and whether the calculated accuracy exceeds a preset threshold may be determined at step S865.

When the accuracy is determined to exceed the preset threshold at step S865, the neural network is determined to be sufficiently trained, and thus training may be terminated.

Also, when it is determined at step S865 that the accuracy does not exceed the preset threshold, steps S810 to S860 are repeatedly performed, whereby training of the neural network is repeatedly performed.

With regard to the repetition of training, it may be determined that one epoch is completed when the entire training dataset stored in the database is fed to the neural network or when only a portion thereof is fed to the neural network using a mini-batch method. Such an epoch may be repeated until a desired accuracy is achieved.

Here, one epoch may mean that forward processing and backpropagation are performed for the entire dataset in an artificial neural network. That is, one epoch may mean that training using the entire dataset is completed once.

Also, the processor 1420 classifies the type of target material by inputting multimodal sensor data pertaining to the target material, which is obtained using a multimodal sensor, to the trained neural network.

For example, assuming that the neural network shown in FIG. 6 and FIG. 7 is a trained neural network, multimodal sensor data pertaining to the target material may be input thereto. Then, the value of the class estimated to have the maximum probability through the neural network may be determined to be the index of the target material.

That is, the target material, which is not yet identified, is measured using the multimodal sensor, and multimodal sensor data, which is the result of measurement, is input to the trained neural network, whereby the classification result indicating the type of target material may be output.

Here, the multimodal sensor data may be collected by repeating an experiment on the target material until the amount thereof becomes equal to or greater than a preset reference amount.

Hereinafter, a process for repeatedly performing an experiment in order to collect multimodal sensor data in the present invention will be described in detail.

Also, the processor 1420 may repeatedly insert and remove at least one type of material to be analyzed in and from the RF resonator a preset number of times using a 3-axis robot. Here, the RF resonator is shielded from an external magnetic field.

For deep learning for analyzing a dielectric constant of chemical material, it is necessary to secure analysis data or training data pertaining to various types of material samples in an environment that is not affected by an external magnetic field.

Therefore, the RF resonator according to an embodiment of the present invention is made of aluminum or brass such that the inner space thereof is not affected by an external magnetic field and such that the electromagnetic wave applied to the interior of the RF resonator is prevented from escaping therefrom. Here, the RF resonator has a structure enabling various types of material to be analyzed to be inserted via a material insertion hole.

For example, the RF resonator according to an embodiment of the present invention may have a cylindrical shape and include a material insertion hole 910, via which the material to be analyzed is inserted in the RF resonator, as shown in FIG. 9. Here, the diameter of the material insertion hole 910 may be freely set when it is designed and produced, but may be set such that the interior of the RF resonator 900 is prevented from being affected by an external magnetic field. The RF resonator 900 is produced in such a way that the upper part and the lower part thereof are combined, whereby an electromagnetic field in a preset frequency range may be formed in the empty space thereof.

For example, when the part 1010 of the RF resonator shown in FIG. 10 is combined with an identical part that is upside down such that the two identical parts form a symmetric shape, a cylindrical RF resonator having empty space therein may be produced, and the corresponding RF resonator may form an electromagnetic field in a preset frequency range in the cylindrical empty space thereof. Also, when the part 1020 of the RF resonator shown in FIG. 10 is combined with an identical part, which is upside down such that the two identical parts form a symmetric shape, an RF resonator, the empty inner space of which has a pentagonal pillar shape, may be produced, and the corresponding RF resonator may form an electromagnetic field in a preset frequency range in the empty inner space having a pentagonal pillar shape.

Also, referring to FIG. 11, the material insertion hole 1111 or 1121 in the RF resonator 1110 or 1120 according to an embodiment of the present invention may be configured to have a different size according to need.

As described above, the RF resonator according to an embodiment of the present invention may be produced so as to have any of various shapes depending on the chemical material to be analyzed or the requirements of an analyzer. However, the structure of the RF resonator is required to enable material to be inserted therein and to enable an electromagnetic field in a certain frequency range to be formed therein. Also, the RF resonator according to an embodiment of the present invention may be produced so as to be suitable for measuring a minute change in material, the main ingredient of which is water, such as distilled water, milk, or the like.

Also, the 3-axis robot according to an embodiment of the present invention may be designed such that it is able to repeatedly place the material to be analyzed in the RF resonator 130, as shown in FIG. 1.

Here, when the material to be analyzed is inserted, the material may be placed in the center of the material insertion hole in the RF resonator using a robot arm, which is capable of entering and leaving the RF resonator via the material insertion hole and is capable of attaching and detaching the material thereto and therefrom.

For example, referring to FIG. 12, the 3-axis robot according to an embodiment of the present invention may include two movement modules 1210 and 1220 for shifting the position of the material to be analyzed, a robot arm 1230 for inserting and removing the material in and from the RF resonator, and a plotter 1240 on which the RF resonator is placed so as to be fixed. That is, the material to be analyzed is attached to the bottom part of the robot arm 1230, and the robot arm 1230 is located above the material insertion hole of the RF resonator using the movement modules 1210 and 1220, whereby it may be ready to repeat the insertion and removal of the material to be analyzed. Then, the material to be analyzed may be inserted into the RF resonator by moving the robot arm 1230 down, or may be removed from the RF resonator by moving the robot arm 1230 up.

Here, the time at which the material to be analyzed is to be removed may be determined in consideration of at least one of whether a signal is measured and a preset signal measurement time.

For example, when it is confirmed that an electromagnetic wave is applied to the RF resonator and a response signal is measured in a network analyzer, which functions to measure a response signal caused by the material to be analyzed, the material to be analyzed may be removed from the RF resonator by controlling the robot arm of the 3-axis robot.

In another example, based on a response signal measurement time, which is the time taken to apply an electromagnetic wave using the network analyzer and to measure a response signal after the material to be analyzed is inserted into the RF resonator, the time at which the material is to be removed may be determined, and the material may be removed at the determined time. If the response signal measurement time is 10 seconds, the material to be analyzed may be removed from the RF resonator 10 seconds after the robot arm inserts the material in the RF resonator.

Here, a movement line, along which the robot arm is to move, may be set in consideration of at least one of the position of the RF resonator relative to that of the 3-axis robot and the depth of the material insertion hole, and the movement of the robot arm may be controlled so as to match the set movement line.

For example, referring to FIG. 1, the distance by which the 3-axis robot is to move along each axis may be set in order to locate the robot arm 121 above the material insertion hole in the RF resonator 130. Then, the distance by which the robot arm 121 is to move may be set based on the depth of the material insertion hole such that the material to be analyzed is located at the center in the RF resonator 130. The movement line is set so as to match the set distances, whereby the movement of the robot arm 121 may be finely controlled.

Also, the processor 1420 may form a magnetic field in a preset frequency range in the RF resonator by applying an electromagnetic wave using a network analyzer while the at least one type of material to be analyzed is placed inside the RF resonator, and may measure a response signal caused by the at least one type of material.

For example, an electromagnetic wave is supplied in units of Hz using a network analyzer, such as a vector network analyzer or a scalar network analyzer, in order to form an electromagnetic field in a frequency range of 0.8 GHz to 3.5 GHz in the RF resonator, and a response signal for analyzing the absorptivity of the material to the electromagnetic field formed in the RF resonator is measured. Here, the scalar network analyzer may provide the same result as when the vector network analyzer is used, except that information about the phase of the response signal is not included in the result.

The network analyzer may apply an electromagnetic wave and measure a response signal only when the material to be analyzed is placed inside the RF resonator. Here, whether the material to be analyzed is placed inside the RF resonator may be determined based on the 3-axis robot control information.

For example, when it is confirmed that the material to be analyzed is inserted in the RF resonator by moving the robot arm based on the 3-axis robot control information, the network analyzer may be controlled so as to apply an electromagnetic wave and to measure a response signal caused by the material to be analyzed.

Also, in the present invention, the time required for postprocessing, that is, for generating multimodal sensor data using the response signal measured through the network analyzer, is measured, and the time at which the robot arm again inserts the material to be analyzed in the RF resonator is calculated based on the measured time, whereby the time at which the network analyzer is to operate may be set.

For example, if it takes 10 seconds for the network analyzer to measure a response signal and generate multimodal sensor data, the robot arm may be controlled so as to again insert the material to be analyzed in the RF resonator 10 seconds after it removes the material from the RF resonator. Accordingly, the network analyzer may also be operated so as to again apply an electromagnetic wave 10 seconds after the robot arm removes the material to be analyzed from the RF resonator, and may then measure a response signal.

Also, the processor 1420 may generate multimodal sensor data based on a response signal.

Here, the multimodal sensor data may be training data to be used to train a neural network, which is for analyzing the dielectric constant of the material to be analyzed. That is, in order to train the neural network so as to accurately analyze the dielectric constant of the material to be analyzed, so as to replace humans, a huge amount of training data may be required.

Therefore, if multimodal sensor data is automatically generated and provided using the method according to the present invention, the percentage of analysis performed by humans is significantly reduced in the process of training a neural network and the process of analyzing chemical material, whereby an analysis result may be more efficiently obtained.

Here, the dielectric constant of the material to be analyzed is calculated using the difference between a first voltage, corresponding to an electromagnetic wave applied to the RF resonator, and a second voltage, corresponding to a response signal, and multimodal sensor data may be generated based on multiple pieces of information about a dielectric constant repeatedly calculated a preset number of times.

Here, the dielectric constant is defined as the proportional amount of a decrease in a magnitude of an electromagnetic field in a dielectric due to the occurrence of dielectric polarization in response to an electromagnetic wave applied to the dielectric. In the present invention, the dielectric constant of the material to be analyzed may be calculated based on the difference between the first voltage and the second voltage, and the repeatedly calculated dielectric constant may be provided as multimodal sensor data for training the neural network.

Here, the network analyzer may include two antennas that can be inserted into the RF resonator in order to calculate a dielectric constant based on the permeability coefficient S₂₁ of S-parameters. For example, referring to FIG. 9, the RF resonator 900 according to an embodiment of the present invention may include two antenna insertion holes 921 and 922 in order to enable the network analyzer to analyze a permeability coefficient S₂₁ of S-parameters.

Here, an electromagnetic wave may be applied using one of the two antennas, and a response signal may be measured using the other antenna.

Here, the two antennas may be broadband antennas or antennas using metal wire. Accordingly, if the two antennas are in contact with the surface of the RF resonator made of metal, an error in the measured signal may result. Therefore, the two antennas according to an embodiment of the present invention may be inserted so as to be prevented from coming into contact with the surface of the RF resonator.

For example, referring to FIG. 9, the two antennas to be inserted in the RF resonator 900 are produced such that the diameter thereof does not exceed the maximum inner width 930 of the RF resonator, whereby the two antennas may be prevented from coming into contact with the metal surface of the RF resonator 900.

The memory 1430 stores multimodal sensor data and a neural network.

Also, the memory 1430 may support the function for analyzing material according to an embodiment of the present invention, as described above. Here, the memory 1430 may function as separate mass storage and include a control function for operation.

Meanwhile, the apparatus for analyzing material may include memory installed therein, thereby storing information in the apparatus. In an embodiment, the memory is a computer-readable recording medium. In an embodiment, the memory may be a volatile memory unit, and in another embodiment, the memory may be a nonvolatile memory unit. In an embodiment, the storage device is a computer-readable recording medium. In different embodiments, the storage device may include, for example, a hard-disk device, an optical disk device, or any other kind of mass storage.

Through the apparatus for analyzing material using a neural network based on multimodal input, there may be provided a method for analyzing the type of material or an extent of reaction to the material using a previously trained neural network without preprocessing the material using a general wet chemical reaction.

Also, a method in which a human performs analysis based on only an RF sensor may be automated in the fields of analytical science and chemical processing, and classification performance may be significantly improved.

Also, not only RF sensor data but also a temperature, a weight, a color, and the like related to the features of the material are simultaneously measured and input to a neural network in a multimodal form so as to be processed, whereby material classification and analysis performance may be significantly improved.

Also, analysis automation based on a neural network is attempted in a field in which artificial intelligence is not commonly used, whereby initiative may be seized in the relevant field.

According to the present invention, there may be provided a method for analyzing the type of a material or an extent of reaction to the material using a previously trained neural network without preprocessing the material using a general wet chemical reaction.

Also, the present invention may greatly improve material classification and analysis performance by simultaneously measuring a temperature, a weight, a color, and the like, related to the characteristics of material, as well as RF sensor data, by inputting the measured data to a neural network in a multimodal form, and by processing the same.

Also, the present invention attempts automation of analysis based on a neural network in the field in which artificial intelligence is not commonly used, thereby seizing initiative in the relevant field.

Also, the present invention may provide an augmentation method suitable for a multimodal sensor in order to prevent overfitting in a neural network.

Also, the present invention may provide a method for merging and processing measured data in a multimodal form in order to improve the signal-to-noise ratio of a multimodal sensor.

As described above, the apparatus and method for analyzing material using a neural network based on multimodal input according to the present invention are not limitedly applied to the configurations and operations of the above-described embodiments, but all or some of the embodiments may be selectively combined and configured, so that the embodiments may be modified in various ways.

What is claimed is:

1. A method for analyzing material using a neural network based on multimodal input, comprising:
obtaining multimodal sensor data pertaining to at least one type of material to be analyzed using a multimodal sensor and augmenting the multimodal sensor data;
merging the multimodal sensor data;
training the neural network using the merged multimodal sensor data; and
inputting multimodal sensor data pertaining to target material, obtained using the multimodal sensor, to the neural network, thereby classifying the type of the target material.

2. The method of claim 1, wherein merging the multimodal sensor data is configured to merge the multimodal sensor data using any one of a first merging method, in which merging is performed when the multimodal sensor data is input, and a second merging method, in which merging is performed when features of the multimodal sensor data are extracted.

3. The method of claim 2, wherein the first merging method includes merging in a data element domain and merging in a data channel domain.

4. The method of claim 2, wherein the second merging method includes merging in a feature element domain and merging in a feature channel domain.

5. The method of claim 1, wherein augmenting the multimodal sensor data is configured to augment data in a manner corresponding to each type of the multimodal sensor data.

6. The method of claim 1, wherein the multimodal sensor includes an RF sensor, a temperature sensor, a weight sensor, a mass sensor, an IR sensor, and an RGB sensor.

7. The method of claim 1, wherein the multimodal sensor data is collected based on a repeated experiment on the at least one type of material until an amount of the multimodal sensor data becomes equal to or greater than a preset reference amount.

8. The method of claim 7, further comprising:
repeatedly inserting and removing the at least one type of material to be analyzed in and from an RF resonator a preset number of times using a 3-axis robot, the RF resonator being shielded from an external magnetic field;
forming a magnetic field in a preset frequency range inside the RF resonator by applying an electromagnetic wave using a network analyzer while the at least one type of material is placed in the RF resonator, and measuring a response signal caused by the at least one type of material; and
generating the multimodal sensor data based on the response signal.

9. The method of claim 8, wherein:
measuring the response signal is configured to determine whether the at least one type of material to be analyzed is placed in the RF resonator based on information about control of the 3-axis robot; and
repeatedly inserting and removing the at least one type of material to be analyzed is configured to determine a time at which the at least one type of material to be analyzed is to be removed in consideration of at least one of whether the response signal is measured and a preset response signal measurement time.

10. The method of claim 8, wherein the network analyzer includes two antennas that are capable of being inserted in the RF resonator, and the two antennas are inserted in the RF resonator such that the two antennas are prevented from coming into contact with a surface of the RF resonator.

11. An apparatus for analyzing material using a neural network based on multimodal input, comprising:
a processor for obtaining multimodal sensor data pertaining to at least one type of material to be analyzed using a multimodal sensor, augmenting the multimodal sensor data, merging the multimodal sensor data, training the neural network using the merged multimodal sensor data, and classifying a type of target material by inputting multimodal sensor data pertaining to the target material, obtained using the multimodal sensor, to the neural network; and
memory for storing the multimodal sensor data and the neural network.

12. The apparatus of claim 11, wherein the processor merges the multimodal sensor data using any one of a first merging method, in which merging is performed when the multimodal sensor data is input, and a second merging method, in which merging is performed when features of the multimodal sensor data are extracted.

13. The apparatus of claim 12, wherein the first merging method includes merging in a data element domain and merging in a data channel domain.

14. The apparatus of claim 12, wherein the second merging method includes merging in a feature element domain and merging in a feature channel domain.

15. The apparatus of claim 11, wherein the processor augments data in a manner corresponding to each type of the multimodal sensor data.

16. The apparatus of claim 11, wherein the multimodal sensor includes an RF sensor, a temperature sensor, a weight sensor, a mass sensor, an IR sensor, and an RGB sensor.

17. The apparatus of claim 11, wherein the multimodal sensor data is collected based on a repeated experiment on the at least one type of material until an amount of the multimodal sensor data becomes equal to or greater than a preset reference amount.

18. The method of claim 17, wherein the processor is configured to:
repeatedly insert and remove the at least one type of material to be analyzed in and from an RF resonator a preset number of times using a 3-axis robot, the RF resonator being shielded from an external magnetic field;
form a magnetic field in a preset frequency range inside the RF resonator by applying an electromagnetic wave using a network analyzer while the at least one type of material to be analyzed is placed in the RF resonator, and measure a response signal caused by the at least one type of material to be analyzed; and
generate the multimodal sensor data based on the response signal.

19. The apparatus of claim 18, wherein the processor determines whether the at least one type of material to be analyzed is placed in the RF resonator based on information about control of the 3-axis robot and determines a time at which the at least one type of material to be analyzed is to be removed in consideration of at least one of whether the response signal is measured and a preset response signal measurement time.

20. The apparatus of claim 18, wherein the network analyzer includes two antennas that are capable of being inserted in the RF resonator, and the two antennas are inserted in the RF resonator such that the two antennas are prevented from coming into contact with a surface of the RF resonator.
